(19) United States
(12) Patent Application Publication
(10) Pub. No.: US 2011/0011000 A1
(43) Pub. Date: Jan. 20, 2011

(54) ALL-GLASS DOOR ARRANGEMENT COMPRISING AN ANTI-FINGER JAMMING MECHANISM

(76) Inventor: Claus Weissofner, Goldegg (AT)

Correspondence Address: KF ROSS PC, 5683 RIVERDALE AVENUE, SUITE 203 BOX 900, BRONX, NY, 10471-0900, US

(21) Appl. No.: 12/921,178

(22) PCT Filed: Mar. 13, 2009
(86) PCT No.: PCT/EP2009/052983

§ 371 Date: Oct. 4, 2010

(30) Foreign Application Priority Data
Apr. 2, 2008 (AT) A517/2008

(51) Int. Cl. E06B 7/36

(52) U.S. Cl. 49/383

(57) ABSTRACT

Disclosed is a door, in particular a frameless glass door, e.g. of a glass swing door or stop-type door, comprising a door leaf (4) in a door opening (6) as well as hinges at the bottom and top or on the sides, said hinges being disposed proximate to a vertical edge of the mounted door leaf (4). In order to avoid the risk of getting caught in a gap remaining between the door leaf (4) and the door opening (6), a gap is provided between the vertical edge of the hinged side of the door leaf (4) and the edge of the door opening (6) opposite the hinge, said gap being covered by a strip (5) which can be swiveled about a vertical axis (8).

### TECHNICAL FIELD

The invention relates to a door according to the preamble of the claim 1.

### PRIOR ART

Known doors of such a type, which substantially comprise only the door leaf, and in particular glass swing doors, have the problem that in many cases the rotation axis does not coincide with the door leaf's edge on the hinge side; the reason for this is that the hinges have to be designed in a relatively stable manner and thus require a certain amount of space so that the actual rotation axis is spaced a few centimeters from the door leaf's edge on the hinge side. With the door open, this results in a relatively wide gap between the hinged edge of the door opening and the corresponding edge of the door leaf, whereas with the door closed, the gap is very small (it only has to compensate for unavoidable tolerances). When reaching into the gap when the door leaf is open (in particular children do this sometimes), the fingers get caught in the gap which becomes more and more narrow when the door closes. If—as it is usually the case—a door closer is provided, due to the required closing forces for the door leaf, very high clamping forces occur which can cause serious injuries. The high forces are due to the fact that the door leaf has also to be retained in the closed position if high wind forces act thereon. Essential for the clamping forces occurring in the mentioned gap are also the leverage ratios which exist for a door leaf and its mounting: in the gap on the hinge side, the forces are significantly higher than in the opposing (lock side) gap.

To avoid this danger, covers can be provided that, however, are quite unattractive.

### OBJECT OF THE INVENTION

It is the object of the invention to avoid these disadvantages and to provide a door of the above-described type, where the risk of getting caught between the door leaf and the edge of the door opening can be reliably avoided (“jam-free”).

This is achieved according to the invention by the characterizing features of claim 1.

With the proposed measures it is possible to subject the strip only to a low force to bias the strip into the closed position. Since the strip can be formed in an appropriately narrow manner, low forces are sufficient to hold the strip in its closed position. When reaching into the gap between the door leaf and the strip (or the between the strip and the door opening) when the door leaf is open, the strip deflects when door closes so that during closing of the door, only a small clamping force can act (in fact only the clamping force of the strip and not that of the door).

It does not matter here if the strip according to claim 2 is mounted on the door leaf or, according to claim 4, on the edge of the door opening. Normally, the rotation axis of the strip in the embodiment according to claim 2 will coincide with the edge of the door leaf, if possible, and in the embodiment according to claim 4 with the edge of the door opening. Thus, only the position of the gap changes: in the first case, it forms between the strip and the door opening and in the second case between the door leaf and the strip. The effect according to the invention is the same in both cases.

Because significantly lower forces act on the strip than on the door leaf, it is not a problem that the rotation axis of the strip coincides relatively precisely with the edge of the door leaf or the edge of the door opening because the hinges can be light-duty; and if the rotation axis coincides precisely with the edge, there is no position of the strip in which an opening is formed between the hinged side of the strip and the adjacent element (door leaf or door opening) that would be large enough to put fingers into; and on the side facing away from the hinge of the strip, the strip can pivot away according to the invention.

A door according to the invention with the features of claim 2 is suitable in particular for glass doors provided in a glass wall, where the door opening is bordered also on the top by the glass wall. Such doors have visible metallic hinges that can also carry the strip. The strip is moved together with the door leaf when it is opened and with the door leaf open, it is possible to reach into the gap formed between the strip and the edge of the door opening. However, during closing of the door leaf, the strip can pivot relative to the door leaf. Since the strip can be kept in alignment with the door leaf by using only a small force, this results in only a small clamping force at the gap between the strip and the door opening and this clamping force does not constitute a risk of injury.

The features of claim 3 ensure in a simple manner that between the adjacent edge surfaces of the door leaf and the strip only a particularly small gap remains to make it impossible to reach into it.

A door according to claim 4 is suitable in particular for doors that extend substantially over the entire height of the room, as described in AT 501292. According to this document, the mount is not visible so that it is difficult to hinge the strip on the door leaf. Here, it is more advantageous if the rotation axis of the strip is stationary, thus, is basically fixed to the edge of the door opening. The door leaf and the strip can have a substantially rectangular cross-section and for the strip, a mounting analog that of the door leaf can be used (see AT 501292). Because only small forces are necessary to align the strip in the closed position, also here, only small clamping forces occur when the door leaf is open and when reaching into the gap between the same and the strip because the strip can easily be pivoted away.

If the mounting of the strip on one of its vertical edges is technically difficult, it is advantageous to provide the features of claim 5, thus, to mount the strip approximately in its center. This results in two gaps (one between the strip and the door leaf and another between the strip and the edge of the door opening) during pivoting of the strip; however, due to the low reset force of the strip, nobody can get injured, no matter in which of these gaps the fingers are placed.

For all doors according to the invention, the strip can be made from the same material, in particular glass, as the door leaf.

### BRIEF DESCRIPTION OF THE DRAWINGS

The invention is now explained in more detail with reference to the drawings. Therein:

FIG. 1 shows a first embodiment of a door according to the invention;

FIG. 2 shows a detail of the door according to FIG. 1;

FIGS. 3 and 4 show schematically the position of the door leaf relative to the strip in different positions;

FIG. 5 shows another embodiment of a door according to the invention; and

FIG. 6 shows a detail of the door according to FIG. 5.

### WAY(S) TO CARRY OUT THE INVENTION

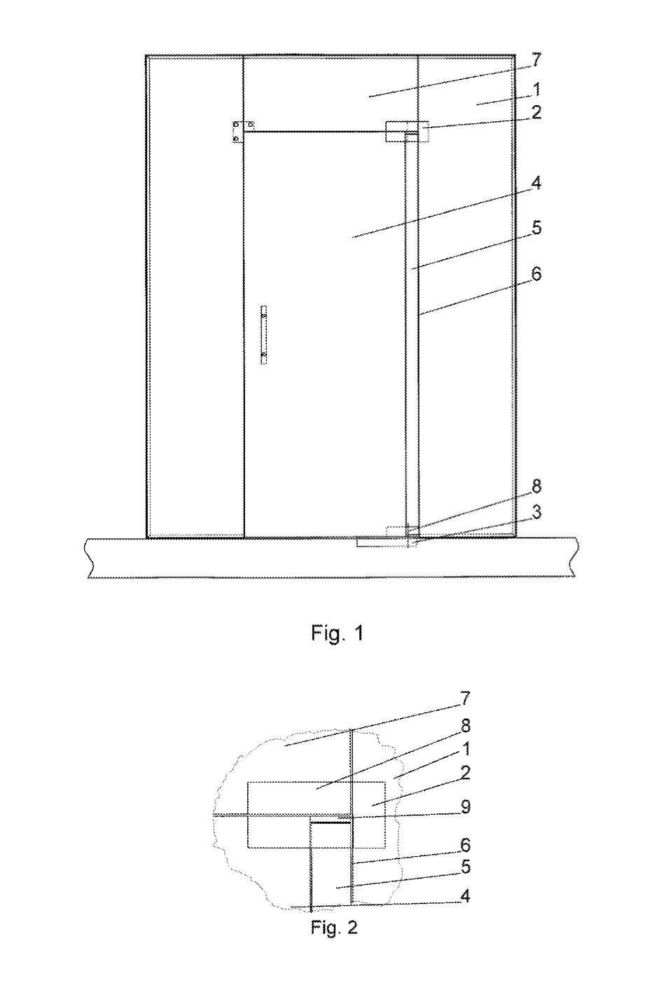

In the embodiment according to FIG. 1, a door leaf 4 and a strip 5 are pivotally retained in a glass wall 1 via fittings 2 and 3. The door leaf 4 and the strip 5 together fill a door opening 6 bordered on the top by a part 7 of the glass wall 1.

The fittings 2 and 3 have pintles that are aligned and vertically oriented and that define a common axis 8 about which the door leaf 4 and the strip 5 can pivot. Here, the axis 8 extends through lugs 9 that can also be formed as fitting parts and engage the strip 5.

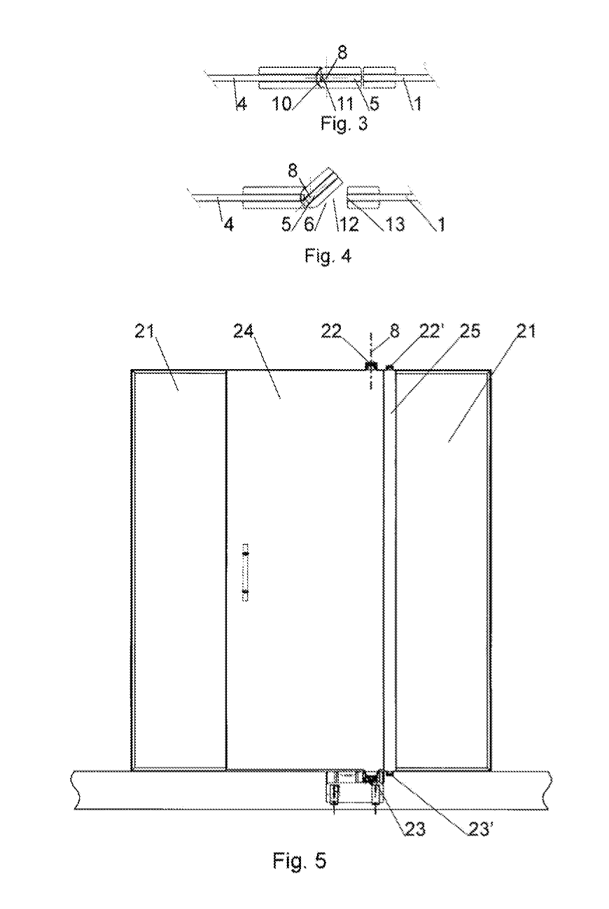

As shown in FIGS. 3 and 4, the vertical confronting edges of the strip 5 and door leaf 4 are arcuately convex and concave with the center of curvature of the arcuate region of the vertical edge of the strip 5 coinciding with the axis 8, and the edge surface 10 of the door leaf 4 is substantially complementary to the confronting strip edge pivot. Here, the edge surface 11 of the strip 5 fits with the edge surface 10 of the door leaf 4.

In the closed position of the door leaf 4 into which the door leaf is biased, the strip 5 is aligned with the door leaf 4 (FIG. 3). For this alignment, very small forces are sufficient (compared to the closing force of the door leaf 4). When the door leaf 4 is open, a gap 12 forms between an edge 13 of the door opening 6 and the strip 5 because the strip 5 moves together with the door leaf 4. If someone reaches into the gap during closing of the door leaf 4, the strip 5 can pivot relative to the door leaf 4 (FIG. 4), with only a relatively small force generated that could not cause an injury.

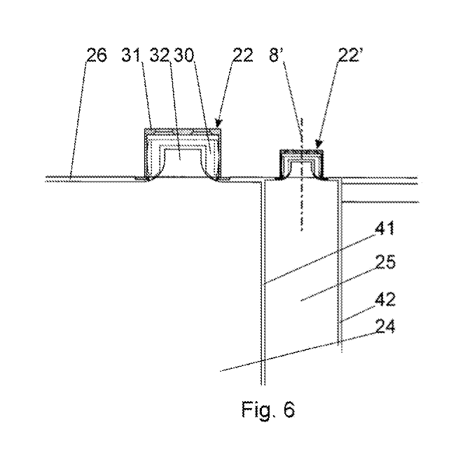

In the embodiment according to the FIGS. 5 and 6, the door leaf 24 is in a glass wall 21 extending substantially over the entire room height, and the fittings 22, 23 are embedded in the ceiling and the floor, respectively. The fitting 22 mainly has a pin-shaped seat 30 for a pivot pin 32 of the door leaf 24, which seat 30 is rotatably retained in a cup-like holder 31 embedded in the ceiling. The fitting 23 embedded in the floor is structured in a similar manner but also holds a mechanism that biases the door leaf 24 into its closed position.

In this embodiment, the door opening 26 extends from the floor to the ceiling.

Here, the door leaf 24 and the strip 25 are of substantially rectangular cross-section. A small gap 41 is formed between the door leaf 24 and the strip 25, and another gap 42 is formed between the strip 25 and the edge of the door opening 26.

The strip 25 can be pivoted in fittings 22′ and 23′ about a separate axis 8′. Here, the strip 25 is biased with a small force into its closed position.

The door leaf can be pivoted independently of the strip 25 about a vertical axis 8 defined by the fittings 22, 23 so that, when reaching into the gap 41 when the door leaf 24 is open, when the door leaf 24 moves toward its closed position, the strip 25 can pivot against a small force and only small forces are generated so that injuries can be excluded. Here, in the illustrated embodiment according to FIGS. 5 and 6, the axis 8′ runs substantially in the center of the strip 25. However, it is also possible to move the axis 8′ away from the door leaf 24 so that it is located at the right edge of the strip 25. In this case, the gap 42 increases only insignificantly during pivoting of the strip 25.

1. A door comprising a door leaf in a door opening and hinges at the bottom and top or on the sides, the hinges being near a vertical edge of the mounted door leaf, wherein a gap is provided between the vertical edge of the hinged side of the door leaf and the edge of the door opening opposite the hinge, the gap being covered by a strip that can pivot about a vertical axis.

2. The door according to claim 1, wherein the pivotal strip is mounted on the door leaf.

3. The door according to claim 2, wherein the pivotal strip has an edge surface of arcuate convex shape facing the door leaf and engages with a confronting concave edge surface of the door leaf, the pivot axis of the strip defining a center of curvature of the convex edge surface of the strip, the door leaf engaging lugs arranged in the upper and lower end region of the door leaf with the strip, the common axis extending through the lugs.

4. The door according to claim 1, wherein the pivotal strip is mounted at the edge of the door opening.

5. The door according to claim 1 wherein the pivot axis of the strip is substantially in a center of the strip.

6. The door according to claim 1 wherein the door is substantially all make of glass and the opening is defined in a glass wall.

7. The door defined in claim 1 wherein the door is substantially all make of glass and the opening is defined in a glass wall.

8. The door defined in claim 1 wherein the strip and the door have interfitting part-circular edges and the strip and the door pivot in the door opening about an axis that lies at a center of curvature of the edges.
